(19) United States
(12) Patent Application Publication
(10) Pub. No.: US 2017/0074287 A1
(43) Pub. Date: Mar. 16, 2017

(54) COMPRESSOR WHEEL-SHAFT ASSEMBLY

(71) Applicant: BorgWarner Inc., Auburn Hills, MI (US)

(72) Inventors: James MAWER, Harrogate (GB); Sanjit CHAGGER, Bradford (GB); Ray CASSON, Bradford (GB); Steve BIRNIE, Well Head (GB)

(21) Appl. No.: 15/124,046

(22) PCT Filed: Mar. 3, 2015
(86) PCT No.: PCT/US2015/018378

§ 371 Date: Sep. 7, 2016

Related U.S. Application Data
(60) Provisional application No. 61/951,060, filed on Mar. 11, 2014.

(51) Int. Cl. F04D 29/62; F01D 25/24; F01D 25/16; F04D 29/056; F04D 29/28; F04D 29/053; F04D 29/051; F01D 5/04; F04D 29/42

(52) U.S. Cl. CPC F04D 29/624; F01D 5/04; F01D 25/24; F01D 25/162; F04D 29/4206; F04D 29/284; F04D 29/053; F04D 29/051; F04D 29/056; F05D 2220/40; F05D 2240/52; F05D 2240/60

(57) ABSTRACT

A turbocharger (1) includes a compressor wheel (50) disposed in a compressor housing (12), a turbine wheel (40) disposed in a turbine housing (11), and a shaft (60) that connects the compressor wheel (50) to the turbine wheel (40). The shaft (60) includes a journal portion (63) that adjoins one end and supports journal bearings (7a, 7b), a thrust portion (64) that adjoins the journal portion (63) that supports a thrust bearing (20), a connection portion (66) that adjoins the thrust portion (64) that has surface features (72) formed on an outer surface thereof, and a guide portion (69) that adjoins the connection portion (66). The guide portion (69) and the connection portion (66) are received within a blind bore (58) of the compressor wheel (50) and are configured to connect the shaft (60) to the compressor wheel (50).

### CROSS-REFERENCE TO RELATED APPLICATIONS

This application claims priority to and all the benefits of U.S. Provisional Application No. 61/951,060, filed on Mar. 11, 2014, and entitled “Compressor Wheel-Shaft Assembly,” which is incorporated herein by reference.

### FIELD OF THE INVENTION

The invention relates to a turbocharger with a shaft having surface features that provide an improved connection to a compressor wheel.

### BACKGROUND OF THE INVENTION

Exhaust gas turbochargers are provided on an engine to deliver air to the engine intake at a greater density than would be possible in a normal aspirated configuration. This allows more fuel to be combusted, thus boosting the engine's horsepower without significantly increasing engine weight.

Generally, an exhaust gas turbocharger includes a turbine section and a compressor section, and uses the exhaust flow from the engine exhaust manifold, which enters the turbine section at a turbine inlet, to drive a turbine wheel located in the turbine housing. The turbine wheel drives a compressor wheel located in the compressor section via a shaft that extends between the sections. Air compressed by the compressor section is then provided to the engine intake as described above. The compressor section of the turbocharger includes the compressor wheel and its associated compressor housing. Filtered air is drawn axially into a compressor air inlet which defines a passage extending axially to the compressor wheel. Rotation of the compressor wheel forces pressurized air flow radially outwardly from the compressor wheel into a compressor volute for subsequent pressurization and flow to the engine.

In some turbochargers, the shaft extends through an axial through-bore formed in the compressor wheel, and a nut that engages a threaded end of the shaft is used to secure the compressor wheel to the shaft.

### SUMMARY

In some aspects, a turbocharger includes a compressor section including a compressor housing, and a compressor wheel disposed in the compressor housing. The turbocharger includes a turbine section including a turbine housing and a turbine wheel disposed in the turbine housing. A shaft connects the compressor wheel to the turbine wheel. The shaft includes a first end that is connected to the turbine wheel, a second end opposed to the first end, the second end connected to the compressor wheel, a journal portion that adjoins the first end and supports a bearing, a thrust portion that adjoins the journal portion and has a smaller cross-sectional dimension than the journal portion, the thrust portion supporting another bearing, a cylindrical connection portion that adjoins the thrust portion, has a smaller cross-sectional dimension than the thrust portion, and has surface features formed on an outer surface thereof, and a guide portion that adjoins the connection portion and includes the second end, the guide portion having a smaller cross-sectional dimension than the connection portion. The guide portion and the connection portion are received within a blind bore of the compressor wheel and are configured to connect the shaft to the compressor wheel.

The turbocharger includes one or more of the following features: The compressor wheel includes a nose, and a backwall that is axially spaced from the nose. The bore opens at the back wall and includes an inner surface that is stepped to correspond to the shape and dimension of the shaft guide portion, connection portion, and thrust portion. The surface features define cavities that are disposed between the outer surface of the connection portion and an inner surface of the bore. The surface features include knurls. An adhesive is disposed between the connection portion and a surface of the bore, and the surface features are configured to retain the adhesive on the connection portion. The guide portion is connected to a first portion of the bore via an interference fit, and the connection portion is connected to a second portion of the bore via an adhesive. The thrust portion is connected to a third portion of the bore via an interference fit. The blind bore of the compressor wheel includes surface features configured to facilitate connection between the compressor wheel and the shaft. The surface features comprise a knurled surface.

In some aspects, a rotating assembly includes a compressor wheel and a shaft. The compressor wheel includes a nose, and a backwall that is axially spaced from the nose, the backwall having a blind bore that opens at the backwall. The shaft includes a first end that is connected to the turbine wheel, a second end opposed to the first end, a journal portion that adjoins the first end, a thrust portion that adjoins the journal portion and has a smaller cross-sectional dimension than the journal portion, a connection portion that adjoins the thrust portion and has a smaller cross-sectional dimension than the thrust portion, and a guide portion that adjoins both the connection portion and the second end, the guide portion having a smaller cross-sectional dimension than the connection portion. The connection portion is cylindrical and has an outer surface that includes shaft surface features configured to retain an adhesive thereon. The bore includes an inner surface that is stepped to correspond to the shape of the shaft guide portion and connection portion. In addition, the guide portion and the connection portion are received within the blind bore of the compressor wheel and are configured to connect the shaft to the compressor wheel.

The rotating assembly may include one or more of the following features: The shaft surface features define cavities that are disposed between the outer surface of the connection portion and an inner surface of the bore. The shaft surface features include knurls. An adhesive is disposed between the connection portion and a surface of the bore. The guide portion is connected to a first portion of the bore via an interference fit, and the connection portion is connected to a second portion of the bore via an adhesive. The blind bore of the compressor wheel includes bore surface features configured to facilitate connection between the compressor wheel and the shaft.

In the exhaust gas turbocharger, the compressor wheel includes a blind bore that receives an end of the shaft therein, and the compressor wheel is secured to the shaft end using an adhesive. Since the bore does not extend to the compressor wheel nose and instead terminates within the compressor wheel hub, the compressor wheel can be formed having a greater working area (e.g., the inlet area for a given diameter of compressor wheel) than some conventional compressor wheels in which the bore extends through the compressor wheel nose. By providing a compressor wheel having a greater inlet area for a given compressor wheel diameter, the compressor wheel can be made smaller for a given amount of air flow, which in turn results in improved transient response of the turbocharger.

In addition, the rotational inertia of the compressor wheel is reduced relative to some compressor wheels having a bore that extends through the compressor wheel nose, due to a reduction in mass for a given inducer area and because the mass is concentrated closer to the axis of rotation. Since the rotational inertia of the compressor wheel is reduced, the transient response of the turbocharger is further improved.

The compressor wheel having the blind bore permits freedom of designing the shape of the compressor wheel nose, which in turn permits a reduction in the aerodynamic drag of the compressor wheel nose relative to some compressor wheels having a bore that extends through the compressor wheel nose to permit securement to the shaft via a nut.

The shaft includes features that facilitate adhesion between the compressor wheel and the shaft outer surface. In particular, knurls are provided on an outer surface of a cylindrical portion of the shaft. The cylindrical shaft shape and knurled surface facilitate proper alignment of the shaft with the compressor wheel, and also provide cavities between the shaft and the inner surface of the compressor wheel that receive and retain the adhesive during assembly. Since the adhesive is retained in the desired area by the knurl cavities, the adhesive is prevented from being squeezed out of the compressor bore during assembly of the shaft with the compressor wheel, whereby the compressor wheel is securely fixed to the shaft.

Other objects and purposes of the invention, and variations thereof, will be apparent upon reading the following specification and inspecting the accompanying drawings.

### BRIEF DESCRIPTION OF THE DRAWINGS

FIG. 1 is a side cross-sectional view of an exhaust gas turbocharger including a shaft that is glued within a blind bore of the compressor wheel.

FIG. 2 is a cross-sectional view of an enlarged portion of the turbocharger of FIG. 1, illustrating the compressor wheel-shaft connection.

FIG. 3 is a cross-sectional view of an isolated compressor wheel.

FIG. 4 is a front perspective view of an end of the turbocharger shaft.

FIG. 5 is a front perspective view of an enlarged portion of the shaft of FIG. 4.

### DETAILED DESCRIPTION

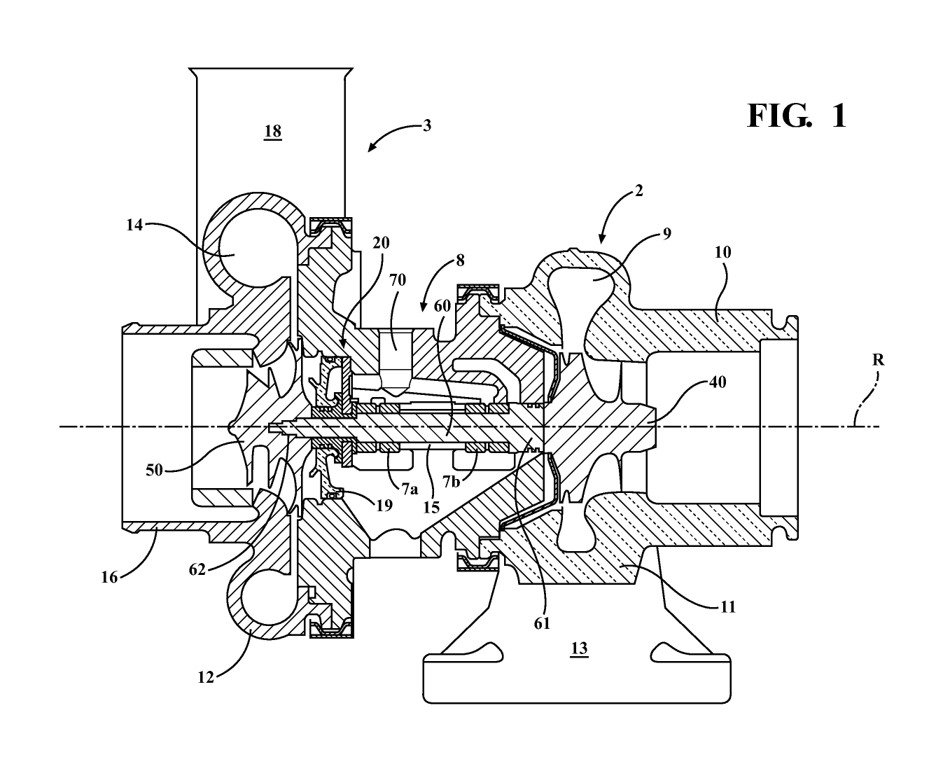

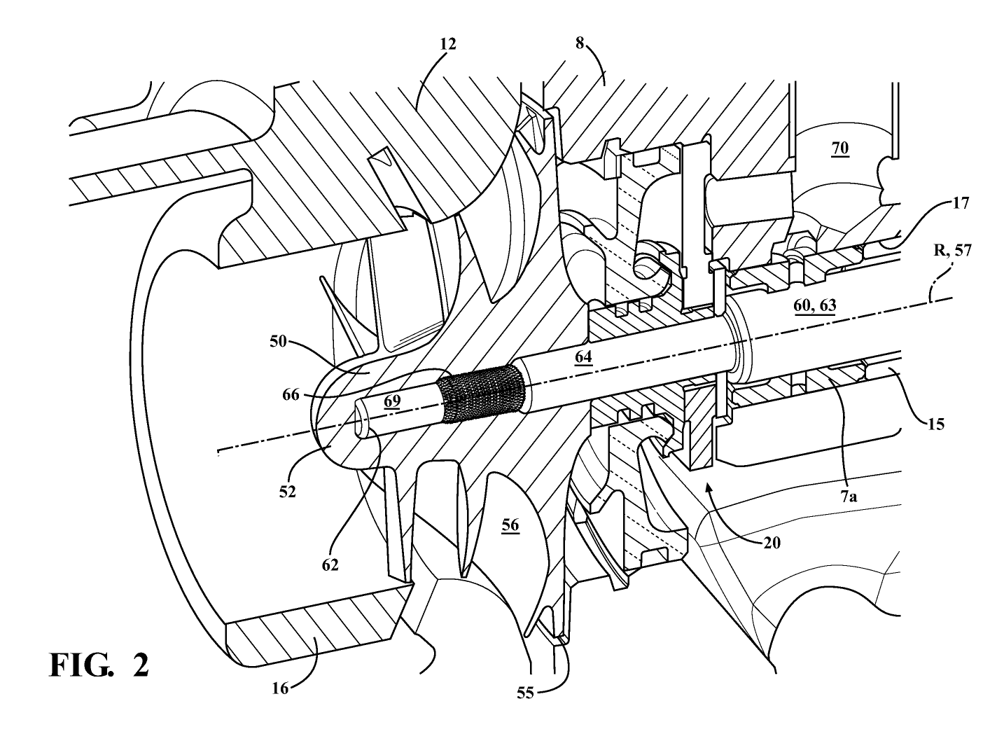

Referring to FIGS. 1 and 2, an exhaust gas turbocharger 1 includes a turbine section 2, the compressor section 3, and a center bearing housing 8 disposed between and connecting the compressor section 3 to the turbine section 2. The turbine section 2 includes a turbine housing 11 that defines an exhaust gas inlet 13, an exhaust gas outlet 10, and a turbine volute 9 disposed in the fluid path between the exhaust gas inlet 13 and exhaust gas outlet 10. A turbine wheel 40 is disposed in the turbine housing 11 between the turbine volute 9 and the exhaust gas outlet 10.

The compressor section 3 includes a compressor housing 12 that defines the air inlet 16, an air outlet 18, and a compressor volute 14. A compressor wheel 50 is disposed in the compressor housing 12 between the air inlet 16 and the compressor volute 14.

A shaft 60 connects the turbine wheel 40 to the compressor wheel 50. The shaft 60 is supported for rotation about a rotational axis R within a bore 17 in the bearing housing 8 via a pair of axially spaced journal bearings 7. For example, a compressor-side journal bearing 7a supports the shaft 60 adjacent the compressor section 3, and a turbine-side journal bearing 7b supports the shaft 60 adjacent to the turbine section 2. The axial spacing between the compressor-side journal bearing 7a and the turbine-side journal bearing 7b is maintained by cylindrical a journal bearing spacer 15. In addition, a thrust bearing assembly 20 is disposed in the bearing housing 8 so as to provide axial support for the shaft 60.

In use, the turbine wheel 40 in the turbine housing 11 is rotatably driven by an inflow of exhaust gas supplied from the exhaust manifold of an engine. Since the shaft 60 is rotatably supported in the bearing housing 8 and connects the turbine wheel 40 to the compressor wheel 50 in the compressor housing 12, the rotation of the turbine wheel 40 causes rotation of the compressor wheel 50. As the compressor wheel 50 rotates, it increases the air mass flow rate, airflow density and air pressure delivered to the engine's cylinders via an outflow from the compressor air outlet 18, which is connected to the engine's air intake manifold (not shown).

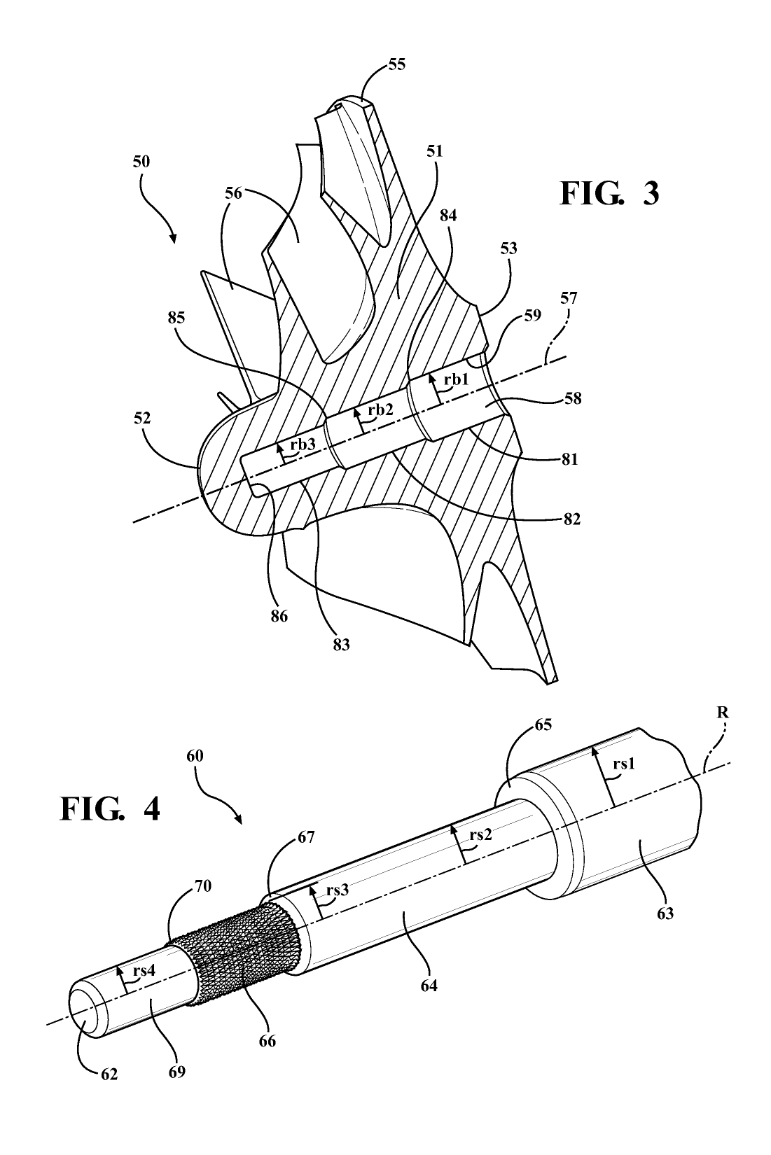

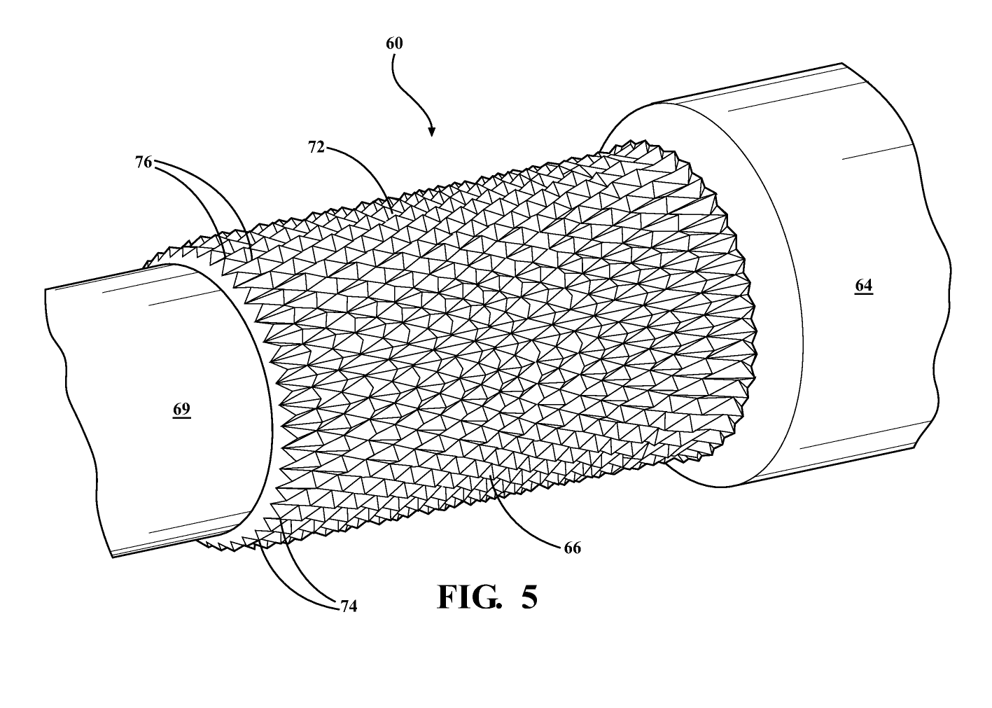

Referring to FIG. 3, the compressor wheel 50 includes a hub 51 extending in an axial direction between a nose 52 on a front side of the compressor wheel 50 and a backwall 53 on a back side of the compressor wheel 50. A peripheral edge 55 of the backwall 53 defines the outer diameter of the compressor wheel 50. The compressor wheel blades 56, which may include full blades alternating with splitter blades, extend outward from the hub 51 and are disposed in a circumferential direction generally at equal intervals around an axis of rotation 57 of the compressor wheel 50.

The compressor wheel 50 also includes a blind bore 58 that extends inward from the backwall 53 coaxially with the axis of rotation 57, and terminates within the hub 51. For example, the bore 58 may extend to a depth that generally corresponds to the axial extent of the blades 56. The bore 58 is cylindrical in cross-sectional shape, and has a non-uniform diameter along the axial direction. In particular, the bore 58 defines a compressor wheel inner surface 59 that includes three stepped, coaxial cylindrical portions 81, 82, 83 having a surface that is generally smooth and regular (e.g., without surface features). The stepped cylindrical portions 81, 82, 83 are formed to correspond to the shape and dimensions of the shaft 60, as discussed further below.

The first cylindrical portion 81 extends between the backwall 53 and a first bore shoulder 84. The first cylindrical portion 81 has a first bore radius rb1. The second cylindrical portion 82 extends between the first bore shoulder 84 and a second bore shoulder 85, and has a second bore radius rb2 that is smaller than the first bore radius rb1. The third cylindrical portion 83 extends between the second bore shoulder 85 and a blind end 86 of the bore 58, and has a third bore radius rb3 that is smaller than the second bore radius rb2. An end 62 of the shaft 60 is received within the bore 58 and secured to the respective cylindrical portions 80, 81, 82, as discussed further below.

Referring to FIGS. 1, 2 and 4, the shaft 60 includes a first end 61 that is welded to the turbine wheel 40, and a second end 62 that is opposed to the first end 61. The shaft 60 is cylindrical in cross-sectional shape, and has a non-uniform diameter along the axial direction such that the shaft 60 has four stepped, coaxial cylindrical portions 63, 64, 66, 69. In particular, a portion of the shaft 60 adjoining the first end 61 provides a journal portion 63. The journal portion 63 is cylindrical (e.g., of uniform diameter and having a circular cross-section), and has a first shaft radius rs1. The journal portion 63 defines the bearing surface that supports the pair of axially spaced journal bearings 7a, 7b. To this end, the journal portion has a length that is sufficient to extend through the axial bore 17 of the bearing housing 8.

The shaft 60 includes a thrust portion 64 that adjoins the journal portion 63. The thrust portion 64 is cylindrical. The outer surface of the thrust portion 64 is generally smooth and regular (e.g., without surface features), and defines the bearing surface that supports the thrust bearing assembly 20. The thrust portion 64 has a second shaft radius rs2 that is smaller than the first shaft radius r1 of the journal portion 63, whereby a first shaft shoulder 65 is defined between the journal portion 63 and the thrust portion 64.

The shaft 60 includes a connection portion 66 that adjoins the thrust portion 64. The connection portion 66 is cylindrical. The connection portion 66 has a third shaft radius rs3 that is smaller than the second shaft radius rs2 of the thrust portion 64, whereby a second shaft shoulder 67 is defined between the thrust portion 64 and the connection portion 66. The outer surface of the connection portion 66 has surface features 72 that facilitate connection of the shaft 60 to the compressor wheel 50. In the illustrated embodiment, the outer surface of the connection portion 66 is knurled.

As used herein, the term “knurled” refers to being formed having a series of ridges 74, for example in which the ridges 74 are arranged to provide a pattern such as a diamond pattern. The knurl is not limited to a diamond pattern, and may alternatively include axially- or circumferentially-aligned ridges, spiral ridges, stippled dots, etc. When the shaft 60 is assembled with the compressor wheel 50, the knurled surface provided on the connection portion 66 provides cavities 76 between the outermost portions of the shaft 60 and the surface of the compressor wheel bore 58. The cavities 76 are the depressions between adjacent ridges 74. The cavities 76 receive and retain adhesive used to secure the shaft 60 to the compressor wheel 50, and ensure that the adhesive is maintained in a well distributed manner over the surface of the connection portion 66.

The shaft 60 further includes a guide portion 69 that adjoins the connection portion 66 and extends between the connection portion 66 and the shaft second end 62. The guide portion 69 is cylindrical. The guide portion 69 has a fourth shaft radius rs4 that is smaller than the third shaft radius rs3 of the connection portion 66, whereby a third shaft shoulder 70 is defined between the connection portion 66 and the guide portion 69. The outer surface of the guide portion 69 is generally smooth and regular (e.g., without surface features). When the shaft 60 is assembled with the compressor wheel 50, the guide portion 69 serves to guide the shaft 60 into the bore 58 and axially align the shaft rotational axis R with the compressor wheel rotational axis 57.

In use, the guide portion 69, the connection portion 66, and a portion of the thrust portion 64 are received within the compressor wheel bore 58. In particular, the guide portion 69 is disposed within the third cylindrical portion 83 of the bore 58 with the shaft second end 62 abutting the bore blind end 86, the connection portion 66 is disposed within the second cylindrical portion 82 of the bore 58 with the third shaft shoulder 70 abutting the second bore shoulder 84, and a portion of the thrust portion 64 is disposed within the first cylindrical portion 81 with the second shaft shoulder 67 abutting the first bore shoulder 84. In addition, the compressor wheel inner surface 59 is dimensioned such that the shaft guide portion 69 has an interference fit with the compressor wheel inner surface 59 in the third cylindrical portion 83, and the shaft thrust portion 64 has an interference fit with the compressor wheel inner surface 59 in the first cylindrical portion 81. In the second cylindrical portion 82, the compressor wheel inner surface 69 is dimensioned such that the radially-outermost tips of the knurls of the connection portion 66 engage the bore surface 59 while the cavities 76 are defined intermediate the bore inner surface 59 and the shaft 60. Adhesive is used to secure the connection portion 66 to the bore inner surface. The adhesive is a high temperature adhesive to withstand the high-temperature working environment of the turbocharger 1. In some embodiments, the adhesive is a high temperature, anaerobic adhesive. Anaerobic adhesives work by completely filling gaps between metal components. Using an anaerobic adhesive prevents loosening from vibration and also protects the joint from corrosion or rust that can result from moisture.

The configuration of the connection portion 66 and the guide portion 69, including their respective cylindrical shapes in combination with the presence of the second and third shoulders 67, 70 and the knurled surface that is provided on the connection portion 66, cooperate to facilitate proper axial and radial alignment of the shaft 60 with the compressor wheel 50.

In the illustrated embodiment, the outer surface of the shaft connection portion 66 is knurled. However, the shaft 60 is not limited to this configuration. For example, in some embodiments, the outer surface of the connection portion 66 is generally smooth and regular (e.g., without surface features). Adhesive is applied to the outer surface of the connection portion 66 to facilitate connection to the compressor wheel 50 as previously described.

In the illustrated embodiment, the compressor wheel inner surface 59 includes the three stepped, coaxial cylindrical portions 81, 82, 83 that are formed without surface features. However, the compressor wheel inner surface 59 is not limited to this configuration. For example, one or more of the cylindrical portions 81, 82, 83, particularly the second cylindrical portion 82, may be formed having surface features such as knurling to provide a key between the compressor wheel inner surface 59 and the shaft 60, and to facilitate retention of the adhesive in place within the bore 58.

Although particular preferred embodiments of the invention have been disclosed in detail for illustrative purposes, it will be recognized that variations or modifications of the disclosed apparatus, including the rearrangement of parts, lie within the scope of the present invention.

I claim:

1. A turbocharger (1) comprising:
a compressor section (3) including a compressor housing (12) and a compressor wheel (50) disposed in the compressor housing (12),
a turbine section (2) including a turbine housing (11) and a turbine wheel (40) disposed in the turbine housing (11), and
a shaft (60) that connects the compressor wheel (50) to the turbine wheel (40), the shaft (60) including
a first end (61) that is connected to the turbine wheel,
a second end (62) opposed to the first end (61), the second end (62) connected to the compressor wheel (50),
a journal portion (63) that adjoins the first end (61) and supports a bearing (7),
a thrust portion (64) that adjoins the journal portion (63) and has a smaller cross-sectional dimension than the journal portion (63), the thrust portion (64) supporting another bearing (20),
a cylindrical connection portion (66) that adjoins the thrust portion (64), has a smaller cross-sectional dimension than the thrust portion (64), and has surface features (72) formed on an outer surface thereof, and
a guide portion (69) that adjoins the connection portion (66) and includes the second end (62), the guide portion (69) having a smaller cross-sectional dimension than the connection portion (66),
wherein
the guide portion (69) and the connection portion (66) are received within a blind bore (58) of the compressor wheel (50) and are configured to connect the shaft (60) to the compressor wheel (50).

2. The turbocharger (1) of claim 1, wherein the compressor wheel (50) includes
a nose (52), and
a backwall (53) that is axially spaced from the nose (52),
wherein the bore (58) opens at the back wall and includes an inner surface (59) that is stepped to correspond to the shape and dimension of the shaft guide portion (69), connection portion (66), and thrust portion (64).

3. The turbocharger (1) of claim 1, wherein the surface features (72) define cavities (76) that are disposed between the outer surface of the connection portion (66) and an inner surface of the bore (58).

4. The turbocharger (1) of claim 3, wherein the surface features (72) include knurls.

5. The turbocharger (1) of claim 1, wherein an adhesive is disposed between the connection portion (66) and a surface of the bore (58), and the surface features (72) are configured to retain the adhesive on the connection portion (66).

6. The turbocharger (1) of claim 1, wherein the guide portion (69) is connected to a first portion (83) of the bore (58) via an interference fit, and the connection portion (66) is connected to a second portion (82) of the bore (58) via an adhesive.

7. The turbocharger (1) of claim 6, wherein the thrust portion (64) is connected to a third portion (81) of the bore (58) via an interference fit.

8. The turbocharger (1) of claim 1, wherein the blind bore (58) of the compressor wheel (50) includes surface features (72) configured to facilitate connection between the compressor wheel (50) and the shaft (60).

9. The turbocharger (1) of claim 8, wherein the surface features (72) comprise a knurled surface.

10. A rotating assembly comprising:
a compressor wheel (50) including
a nose (52), and
a backwall (53) that is axially spaced from the nose (52), the backwall (53) having a blind bore (58) that opens at the backwall (53), and
a shaft (60) including
a first end (61) that is connected to the turbine wheel,
a second end (62) opposed to the first end (61),
a journal portion (63) that adjoins the first end (61),
a thrust portion (64) that adjoins the journal portion (63) and has a smaller cross-sectional dimension than the journal portion (63),
a connection portion (66) that adjoins the thrust portion (64) and has a smaller cross-sectional dimension than the thrust portion (64), and
a guide portion (69) that adjoins both the connection portion (66) and the second end (62), the guide portion (69) having a smaller cross-sectional dimension than the connection portion (66),
wherein the connection portion (66) is cylindrical and has an outer surface that includes shaft surface features (72) configured to retain an adhesive thereon, and
the bore (58) includes an inner surface that is stepped to correspond to the shape of the shaft guide portion (69) and connection portion (66), and
the guide portion (69) and the connection portion (66) are received within the blind bore (58) of the compressor wheel (50) and are configured to connect the shaft (60) to the compressor wheel (50).

11. The rotating assembly of claim 10, wherein the shaft surface features (72) define cavities (76) that are disposed between the outer surface of the connection portion (66) and an inner surface of the bore (58).

12. The rotating assembly of claim 11, wherein the shaft surface features (72) include knurls.

13. The rotating assembly of claim 10, wherein an adhesive is disposed between the connection portion (66) and a surface of the bore (58).

14. The rotating assembly of claim 10, wherein the guide portion (69) is connected to a first portion of the bore (58) via an interference fit, and the connection portion (66) is connected to a second portion of the bore (58) via an adhesive.

15. The rotating assembly of claim 10, wherein the blind bore (58) of the compressor wheel (50) includes bore (58) surface features (72) configured to facilitate connection between the compressor wheel (50) and the shaft (60).
